(19) United States
(12) Patent Application Publication
(10) Pub. No.: US 2001/0037447 A1
(43) Pub. Date: Nov. 1, 2001

(54) Simultaneous and redundantly threaded processor branch outcome queue

(76) Inventors: Shubhendu S. Mukherjee, Framingham, MA (US); Steven K. Reinhardt, Ann Arbor, MI (US)

Correspondence Address: CONLEY ROSE & TAYON, P.C., P. O. BOX 3267, HOUSTON, TX, 77253-3267, US

(21) Appl. No.: 09/838,078

(22) Filed: Apr. 19, 2001

Related U.S. Application Data
(60) Provisional application No. 60/198,530, filed on Apr. 19, 2000.

(51) Int. Cl. G06F 9/00

(52) U.S. Cl. 712/239; 712/235

(57) ABSTRACT

A pipelined, simultaneous and redundantly threaded (“SRT”) processor configured to detect transient faults during program execution by executing instructions in at least two redundant copies of a program thread and wherein misspeculation caused by incorrectly predicting the outcomes of branch instructions in a second program thread is avoided by using the actual outcomes of branch instructions in a first program thread to correctly predict the outcome of branch instructions in the second program thread. The SRT processor comprises a branch predictor for speculating the outcomes of branch instructions in the first program thread and a branch outcome queue for storing the actual outcomes of branch instructions in the first program thread. The processor uses the branch outcome queue and not the branch predictor to predict the outcomes of branch instructions in the second program thread.

### CROSS-REFERENCE TO RELATED APPLICATIONS

This application is a non-provisional application claiming priority to provisional application Ser. No. 60/198,530, filed on Apr. 19, 2000, entitled “Transient Fault Detection Via Simultaneous Multithreading,” the teachings of which are incorporated by reference herein.

This application is further related to the following co-pending applications, each of which is hereby incorporated herein by reference:

U.S. patent application Ser. No. ______, filed ______, and entitled “Slack Fetch to Improve Performance of a Simultaneous and Redundantly Threaded Processor,” Attorney Docket No. 1662-23801;

U.S. patent application Ser. No. ______,filed ______, and entitled “Simultaneously and Redundantly Threaded Processor Store Instruction Comparator,” Attorney Docket No. 1662-36900;

U.S. patent application Ser. ______, No. ______, filed , and entitled “Cycle Count Replication in a Simultaneous and Redundantly Threaded Processor,” Attorney Docket No. 1662-37000;

U.S. patent application Ser. No. ______, filed ______, and entitled “Active Load Address Buffer,” Attorney Docket No. 1662-37100;

U.S. patent application Ser. No. ______, filed ______, and entitled “Input Replicator for Interrupts in a Simultaneous and Redundantly Threaded Processor,” Attorney Docket No. 1662-37300;

U.S. patent application Ser. No. ______, filed ______, and entitled “Simultaneously and Redundantly Threaded Processor Uncached Load Address Comparator and Data Value Replication Circuit,” Attorney Docket No. 1662-37400;

U.S. patent application Ser. No. ______, filed ______, and entitled “Load Value Queue Input Replication in a Simultaneous and Redundantly Threaded Processor,” Attorney Docket No. 1662-37500.

### BACKGROUND OF THE INVENTION

1. Field of the Invention

The present invention generally relates to microprocessors. More particularly, the present invention relates to a pipelined, multithreaded processor that can execute a program in at least two separate, redundant threads. More particularly still, the invention relates to locating branch outcomes from a leading program thread into a queue for access by a trailing program thread to reduce branch misspeculation and improve processor performance.

### BACKGROUND OF THE INVENTION

Solid state electronics, such as microprocessors, are susceptible to transient hardware faults. For example, cosmic rays or alpha particles can alter the voltage levels that represent data values in microprocessors, which typically include millions of transistors. Cosmic radiation can change the state of individual transistors causing faulty operation. The frequency of such transient faults is relatively low-typically less than one fault per year per thousand computers. Because of this relatively low failure rate, making computers fault tolerant currently is attractive more for mission-critical applications, such as online transaction processing and the space program, than computers used by average consumers. However, future microprocessors will be more prone to transient fault due to their smaller anticipated size, reduced voltage levels, higher transistor count, and reduced noise margins. Accordingly, even low-end personal computers may benefit from being able to protect against such faults.

One way to protect solid state electronics from faults resulting from cosmic radiation is to surround the potentially effected electronics by a sufficient amount of concrete. It has been calculated that the energy flux of the cosmic rays can be reduced to acceptable levels with six feet or more of concrete surrounding the computer containing the chips to be protected. For obvious reasons, protecting electronics from faults caused by cosmic ray with six feet of concrete usually is not feasible. Further, computers usually are placed in buildings that have already been constructed without this amount of concrete.

Rather than attempting to create an impenetrable barrier through which cosmic rays cannot pierce, it is generally more economically feasible and otherwise more desirable to provide the affected electronics with a way to detect and recover from a fault caused by cosmic radiation. In this manner, a cosmic ray may still impact the device and cause a fault, but the device or system in which the device resides can detect and recover from the fault. This disclosure focuses on enabling microprocessors (referred to throughout this disclosure simply as “processors”) to recover from a fault condition. One technique, such as that implemented in the Compaq Himalaya system, includes two identical “lockstepped” microprocessors. Lockstepped processors have their clock cycles synchronized and both processors are provided with identical inputs (i.e., the same instructions to execute, the same data, etc.). A checker circuit compares the processors' data output (which may also include memory addressed for store instructions). The output data from the two processors should be identical because the processors are processing the same data using the same instructions, unless of course a fault exists. If an output data mismatch occurs, the checker circuit flags an error and initiates a software or hardware recovery sequence. Thus, if one processor has been affected by a transient fault, its output likely will differ from that of the other synchronized processor. Although lockstepped processors are generally satisfactory for creating a fault tolerant environment, implementing fault tolerance with two processors takes up valuable real estate.

A “pipelined” processor includes a series of functional units (e.g., fetch unit, decode unit, execution units, etc.), arranged so that several units can be simultaneously processing an appropriate part of several instructions. Thus, while one instruction is being decoded, an earlier fetched instruction can be executed. A “simultaneous multithreaded” (“SMT”) processor permits instructions from two or more different program threads (e.g., applications) to be processed through the processor simultaneously. An “out-of-order” processor permits instructions to be processed in an order that is different than the order in which the instructions are provided in the program (referred to as “program order”). Out-of-order processing potentially increases the throughput efficiency of the processor. Accordingly, an SMT processor can process two programs simultaneously.

An SMT processor can be modified so that the same program is simultaneously executed in two separate threads to provide fault tolerance within a single processor. Such a processor is called a simultaneous and redundantly threaded (“SRT”) processor. Some of the modifications to turn a SMT processor into an SRT processor are described in Provisional Application Ser. No. 60/198,530.

Executing the same program in two different threads permits the processor to detect faults such as may be caused by cosmic radiation, noted above. By comparing the output data from the two threads at appropriate times and locations within the SRT processor, it is possible to detect whether a fault has occurred. For example, data written to cache memory or registers that should be identical from corresponding instructions in the two threads can be compared. If the output data matches, there is no fault. Alternatively, if there is a mismatch in the output data, a fault has presumably occurred in one or both of the threads.

Executing the same program in two separate threads advantageously affords the SRT processor some degree of fault tolerance, but also may cause several performance problems. For instance, any latency caused by a cache miss is exacerbated. Cache misses occur when an instruction requests data from memory that is not also available in cache memory. The processor first checks whether the requested data already resides in the faster access cache memory, which generally is onboard the processor die. If the requested data is not present in cache (a condition referred to as a cache “miss”), then the processor is forced to retrieve the data from main system memory which takes more time, thereby causing latency, than if the data could have been retrieved from the faster onboard cache. Because the two threads are executing the same instructions, any instruction in one thread that results in a cache miss will also experience the same cache miss when that same instruction is executed in other thread. That is, the cache latency will be present in both threads.

A second performance problem concerns branch misspeculation. A branch instruction requires program execution either to continue with the instruction immediately following the branch instruction if a certain condition is met, or branch to a different instruction if the particular condition is not met. Accordingly, the outcome of a branch instruction is not known until the instruction is executed. In a pipelined architecture, a branch instruction (or any instruction for that matter) may not be executed for at least several, and perhaps many, clock cycles after the branch instruction is fetched by the fetch unit in the processor. In order to keep the pipeline full (which is desirable for efficient operation), a pipelined processor includes branch prediction logic which predicts the outcome of a branch instruction before it is actually executed (also referred to as “speculating”). Branch prediction logic generally bases its speculation on short or long term history. As such, using branch prediction logic, a processor's fetch unit can speculate the outcome of a branch instruction before it is actually executed. The speculation, however, may or may not turn out to be accurate. That is, the branch predictor logic may guess wrong regarding the direction of program execution following a branch instruction. If the speculation proves to have been accurate, which is determined when the branch instruction is executed by the processor, then the next instructions to be executed have already been fetched and are working their way through the pipeline.

If, however, the branch speculation turns out to have been the wrong prediction (referred to as “misspeculation”), many or all of the instructions filling the pipeline behind the branch instruction may have to be thrown out (i.e., not executed) because they are not the correct instructions to be executed after the branch instruction. The result is a substantial performance hit as the fetch unit must fetch the correct instructions to be processed through the pipeline. Suitable branch prediction methods, however, result in correct speculations more often than misspeculations and the overall performance of the processor is improved with a suitable branch predictor (even in the face of some misspeculations) than if no speculation was available at all.

In an SRT processor that executes the same program in two different threads for fault tolerance, any branch misspeculation is exacerbated because both threads will experience the same misspeculation. Because the branch misspeculation occurs in both threads, the processor's internal resources usable to each thread are wasted while the wrong instructions are replaced with the correct instructions.

Of course, it is always desirable to improve the efficiency in a processor. Accordingly, any increase in efficiency, and thus speed, of an SRT processor is highly desirable. Similarly, improvements in the efficiency of a simultaneous multithreaded processor capable of executing the same instruction set as two separate threads for fault tolerance also is desirable.

### BRIEF SUMMARY OF THE INVENTION

The problems noted above are solved in large part by a simultaneous and redundantly threaded processor that can simultaneously execute the same program in two separate threads to provide fault tolerance. By simultaneously executing the same program twice, the system can be made fault tolerant by checking the output data pertaining to corresponding instructions in the threads to ensure that the data matches. A data mismatch indicates a fault in the processor effecting one or both of the threads. The preferred embodiment of the invention provides an increase in performance to such a fault tolerant, simultaneous and redundantly threaded processor.

The preferred embodiment includes a pipelined, simultaneous and redundantly threaded (“SRT”) processor comprising a fetch unit that fetches instructions from a plurality of threads of instructions and a program counter configured to assign program counter value identifiers to instructions in each thread that are fetched by the fetch unit. The SRT processor is configured to detect transient faults during program execution by executing instructions in at least two redundant copies of a program thread. Misspeculation caused by incorrectly predicting the outcomes of branch instructions in a second, trailing program thread is avoided by using the actual outcomes of branch instruction from a first, leading program thread to correctly predict the outcome of branch instructions in the second program thread.

The instructions in the first program thread execute in advance of the corresponding instructions in the second program thread thereby creating a slack of instructions between the first and second program threads. Preferably, the slack is sufficient to allow the SRT processor to resolve any misspeculation in the first program thread prior to providing correct branch outcome results to the second program thread. The preferred embodiment may use a slack counter configured to maintain a target number of instructions of separation between corresponding instructions in the leading and trailing threads. The preferred embodiment of the SRT processor is an out-of-order processor capable of executing instructions in the most efficient order, but all branch instructions are executed in program order in both the first and second program threads.

The SRT processor includes a branch predictor for predicting the outcomes of branch instructions in the first program thread and a branch outcome queue for storing the actual outcomes of branch instructions from the first program thread. The outcomes from the first thread are preferably stored in the branch outcome queue after the branch instructions in the first program thread are retired by the SRT processor. The fetch unit then uses the branch outcome queue and not the branch predictor to predict the outcomes of branch instructions in the second program thread. The branch outcome queue is preferably implemented using a FIFO buffer. The individual outcomes stored in the branch outcome queue comprise a program counter value assigned to the branch instruction by the program counter and a target address corresponding to the instruction to be executed immediately following the branch instruction. During execution of the second program thread, the SRT processor may identify the appropriate branch instruction using the program counter value and may also speculate and fetch instructions ahead of the branch instruction using the target address.

In the event the branch outcome queue becomes full, the first thread is stalled to prevent more branch outcomes from entering the branch outcome queue. Conversely, if the branch outcome queue becomes empty, the second thread is stalled to allow more branch outcomes to enter the branch outcome queue.

### BRIEF DESCRIPTION OF THE DRAWINGS

For a detailed description of the preferred embodiments of the invention, reference will now be made to the accompanying drawings in which:

FIG. 1 is a diagram of a computer system constructed in accordance with the preferred embodiment of the invention and including a simultaneous and redundantly threaded processor;

FIG. 2 is a graphical depiction of the input replication and output comparison executed by the simultaneous and redundantly threaded processor according to the preferred embodiment;

FIG. 3 conceptually illustrates the slack between the execution of two threads containing the same instruction set but with one thread trailing the other thread;

FIG. 4 is a block diagram of the simultaneous and redundantly threaded processor from FIG. 1 in accordance with the preferred embodiment that includes a branch outcome queue to eliminate misspeculation in a trailing thread;

FIG. 5 is a diagram of a Register Update Unit in accordance with a preferred embodiment; and

FIG. 6 is a diagram of a Branch Outcome Queue in accordance with a preferred embodiment.

### NOTATION AND NOMENCLATURE

Certain terms are used throughout the following description and claims to refer to particular system components. As one skilled in the art will appreciate, microprocessor companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

The term “slack” is intended to mean the number of instructions that one thread is ahead of another thread that is executing the same instruction set. For example, a slack of 256 instructions means that the processor will give one thread a 256 instruction “head start” over another thread having the same instruction set in terms of fetching instructions. Accordingly, the processor will not fetch the first instruction from the delayed thread until the processor has fetched the 256^{th} instruction from the leading thread.

The term “branch” refers to a logical decision or any other type of change in control flow in a program thread. For instance, a logical “IF-ELSE” branch may provide an entry to one of several paths depending on the outcome of the command. Similarly, a subroutine call is also considered a branch because it requires a jump from the main program routine. In general, a branch may comprise any command in which the control of the program flow is altered.

### DETAILED DESCRIPTION OF THE PREFERRED EMBODIMENTS

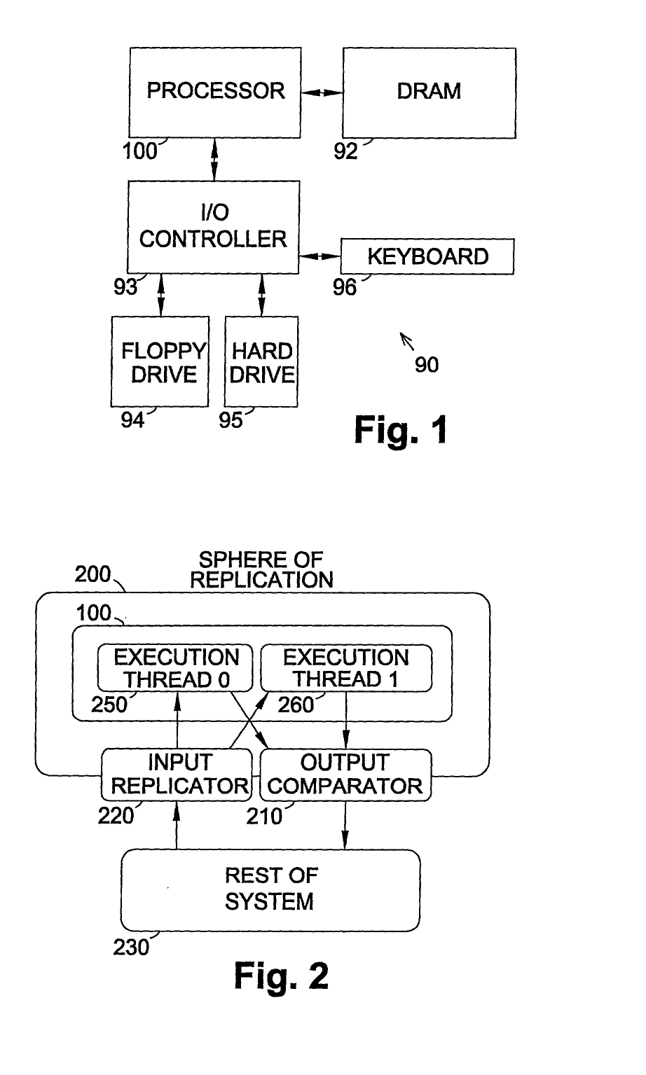

FIG. 1 shows a computer system 90 including a pipelined, simultaneous and redundantly threaded (“SRT”) processor 100 constructed in accordance with the preferred embodiment of the invention. In addition to processor 100, computer system 90 also includes dynamic random access memory (“DRAM”) 92, an input/output (“I/O”) controller 93, and various I/O devices which may include a floppy drive 94, a hard drive 95, a keyboard 96, and the like. The I/O controller 93 provides an interface between processor 100 and the various I/O devices 94-96. The DRAM 92 can be any suitable type of memory devices such as RAMBUS™ memory. In addition, SRT processor 100 may also be coupled to other SRT processors if desired in a commonly known “Manhattan” grid, or other suitable architecture.

The preferred embodiment of the invention provides a performance enhancement to SRT processors. The preferred SRT processor 100 described above is capable of processing instructions from two different threads simultaneously. Such a processor in fact can be made to execute the same program as two different threads. In other words, the two threads contain the same program set. Processing the same program through the processor in two different threads permits the processor to detect faults caused by cosmic radiation as noted above.

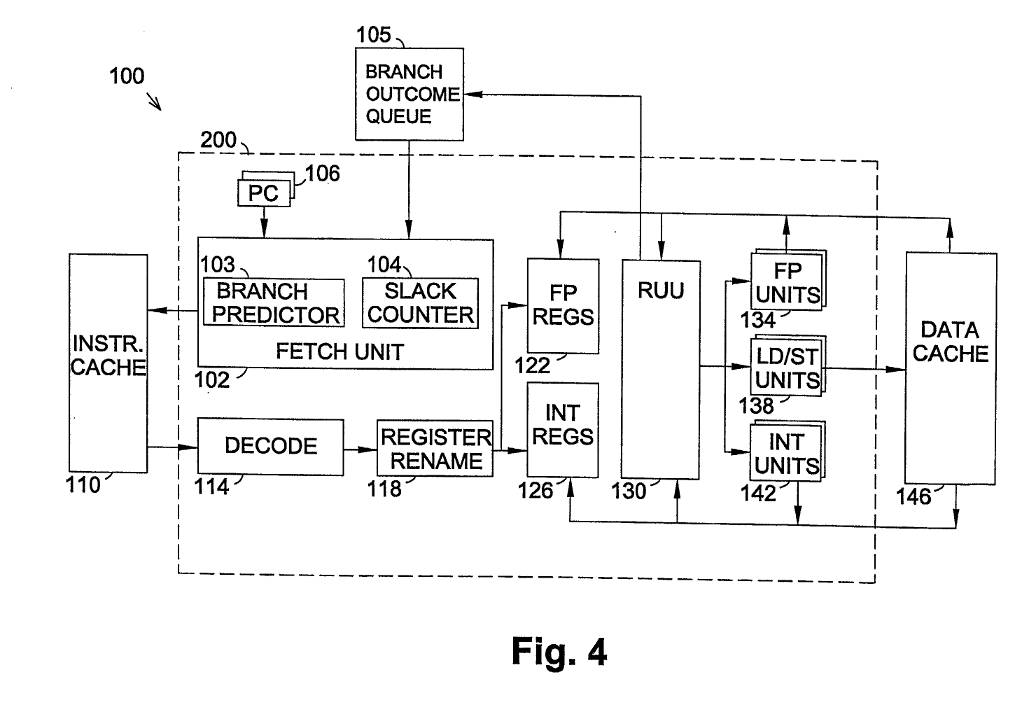

FIG. 2 conceptually shows the simultaneous and redundant execution of threads 250, 260 in the processor 100. The threads 250, 260 are referred to as Thread 0 (“T0”) and Thread 1 (“T1”). In accordance with the preferred embodiment, the processor 100 or a significant portion thereof resides in a sphere of replication 200, which defines the boundary within which all activity and states are replicated. Values that cross the boundary of the sphere of replication are the outputs and inputs that require comparison 210 and replication 220, respectively. Thus, a sphere of replication 200 that includes fewer components may require fewer replications but may also require more output comparisons because more information crosses the boundary of the sphere of replication. The preferred sphere of replication is described in conjunction with the discussion of FIG. 4 below.

All inputs to the sphere of replication 200 must be replicated 220. For instance, an input resulting from a memory load command must return the same value to each execution thread 250, 260. If two distinctly different values are returned, the threads 250, 260 may follow divergent execution paths. Similarly, the outputs of both threads 250, 260 must be compared 210 before the values contained therein are shared with the rest of the system 230. For instance, each thread may need to write data to memory 92 or send a command to the I/O controller 93. If the outputs from the threads 250, 260 are identical, then it is assumed that no transient faults have occurred and a single output is forwarded to the appropriate destination and thread execution continues. Conversely, if the outputs do not match, then appropriate error recovery techniques may be implemented to re-execute and re-verify the “faulty” threads.

It should be noted that the rest of the system 230, which may include such components as memory 92, I/O devices 93-96, and the operating system need not be aware that two threads of each program are executed by the processor 100. In fact, the preferred embodiment generally assumes that all input and output values or commands are transmitted as if only a single thread exists. It is only within the sphere of replication 200 that the input or output data is replicated.

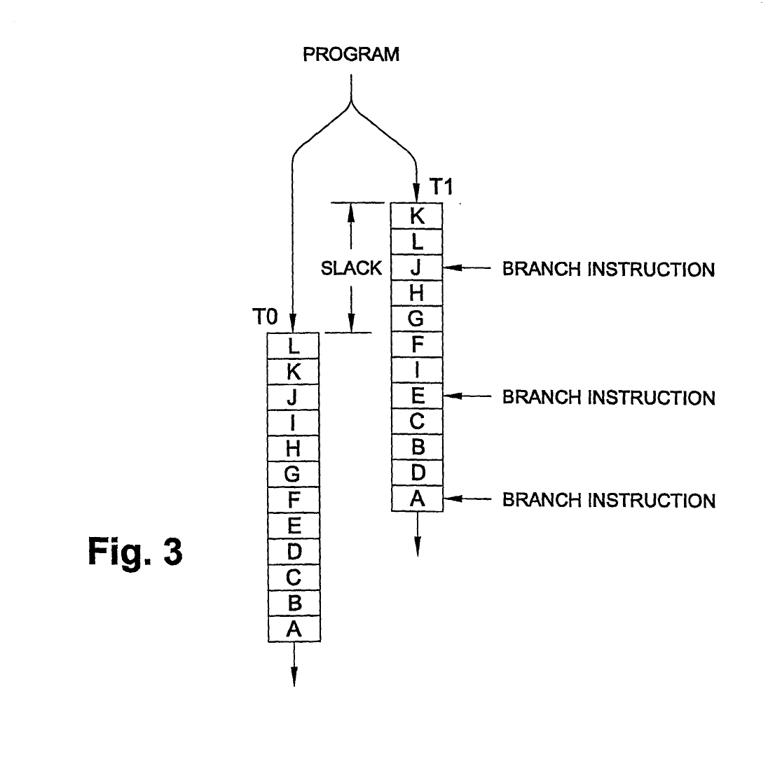

FIG. 3 shows two distinct, but replicated copies of a program thread T0 & T1 presumably executed in the same pipeline. Thread T0 is arbitrarily designated as the “leading” thread while thread T1 is designated as the “trailing” thread. The threads may be separated in time by a predetermined slack and may also be executed out of program order. Slack is a generally desirable condition in an SRT processor 100 and may be implemented by a dedicated slack fetch unit as described below or using a branch outcome queue in accordance with the preferred embodiment. The branch outcome queue is described in more detail below.

The amount of slack in the example of FIG. 3 is five instructions. In general, the amount of slack can be any desired number of instructions. For example, as shown in Provisional patent application No. 60/198530 filed on Apr. 19, 2000, an optimal slack of 256 instructions was shown to provide a performance increase without introducing unnecessary overhead. The amount of slack can be preset or programmable by the user of computer system 90 and preferably is large enough to permit the leading thread to resolve some, most, or all cache misses and branch misspeculations before the corresponding instructions from the trailing thread are executed. It will also be understood by one of ordinary skill in the art that, in certain situations, the two threads will have to be synchronized thereby reducing the slack to zero. Examples of such situations include uncached loads and external interrupts.

As discussed above, the preferred embodiment of the SRT processor 100 is capable of executing instructions out of order to achieve maximum pipeline efficiency. Instructions in the leading thread are fetched and retired in program order, but may be executed in any order that keeps the pipeline full. In the preferred embodiment, however, cached loads in the trailing thread are fetched, executed, and retired by the processor in program order. For example, in the representative example shown in FIG. 3, the stack on the left represents instructions as they are retired by the leading thread T0. The instructions in the leading thread T0 may have been executed out-of-order, but they are retired in their original, program order. The stack on the right represents the execution order for instructions in the trailing thread T1. Instructions A, E, and J represent cache load instructions. The remaining instructions may or may not depend on instructions A, E, and J and may or may not be executed in program order. It is assumed however, in accordance with the preferred embodiment that non-load instructions may be executed out of order. Thus, instructions B-D, F-I and K-L may be executed in different orders while load instructions A, E, and J are executed in their original order.

Referring now to FIG. 4, processor 100 preferably comprises a pipelined architecture which includes a series of functional units, arranged so that several units can be simultaneously processing appropriate parts of several instructions. As shown, the exemplary embodiment of processor 100 includes a fetch unit 102, one or more program counters 106, an instruction cache 110, decode logic 114, register rename logic 118, floating point and integer registers 122, 126, a register update unit 130, execution units 134, 138, and 142, a data cache 146, and branch outcome queue 105.

Fetch unit 102 uses a program counter 106 associated with each thread for assistance as to which instruction to fetch. Being a multithreaded processor, the fetch unit 102 preferably can simultaneously fetch instructions from multiple threads. A separate program counter 106 is associated with each thread. Each program counter 106 is a register that contains the address of the next instruction to be fetched from the corresponding thread by the fetch unit 102. FIG. 4 shows two program counters 106 to permit the simultaneous fetching of instructions from two threads. It should be recognized, however, that additional program counters can be provided to fetch instructions from more than two threads.

As shown, fetch unit 102 includes branch prediction logic 103 and a “slack” counter 104. Slack counter 104 is used to create a delay of a desired number of instructions between the two threads that include the same instruction set. The slack counter 104 preferably is a signed counter that is decremented when the leading thread T0 commits an instruction (“committing” an instruction refers to the process of completing the execution of and retiring an instruction). Further, the counter is incremented when the trailing thread commits an instruction. The counter 104 preferably is initialized at system reset to the target slack. The fetch policy implemented by the fetch unit 102 preferably is to give priority to the thread that generally has the fewest number of instructions in the instruction cache 110, decode 114, and register rename 118. This fetch policy can be implemented by fetching instructions from the thread whose program counter 106 has a lower value than the other program counter associated with the other thread. This process automatically guides the fetch unit 102 to maintain the desired instruction slack.

The branch prediction logic 103 permits the fetch unit 102 to speculate ahead on branch instructions in the leading thread T0 as noted above. In order to keep the pipeline full (which is desirable for efficient operation), the branch predictor logic 103 speculates the outcome of a branch instruction before the branch instruction is actually executed. Branch predictor 103 generally bases its speculation on previous instructions. Any suitable speculation algorithm can be used in branch predictor 103.

The branch predictor 103 is a rather elaborate structure. However, as a crude example, the branch predictor 103 may be thought of as an index table that includes branch instructions for the program thread and a predicted branch outcome corresponding to each instruction in the table. Thus, when the fetch unit probes the branch predictor 103, the anticipated result of a branch instruction is looked up and the subsequent instructions are then executed in reliance of that predicted outcome.

Referring still to FIG. 4, instruction cache 110 provides a temporary storage buffer for the instructions to be executed. Decode logic 114 retrieves the instructions from instruction cache 110 and determines the instruction type (e.g., add, subtract, load, store, etc.). Decoded instructions are then passed to the register rename logic 118 which maps logical registers onto a pool of physical registers.

The register update unit (“RUU”) 130 provides an instruction queue for the instructions to be executed. The RUU 130 serves as a combination of global reservation station pool, rename register file, and reorder buffer. The RUU 130 breaks load and store instructions into an address portion and a memory (i.e., register) reference. The address portion is placed in the RUU 130, while the memory reference portion is placed into a load/store queue (not specifically shown in FIG. 4).

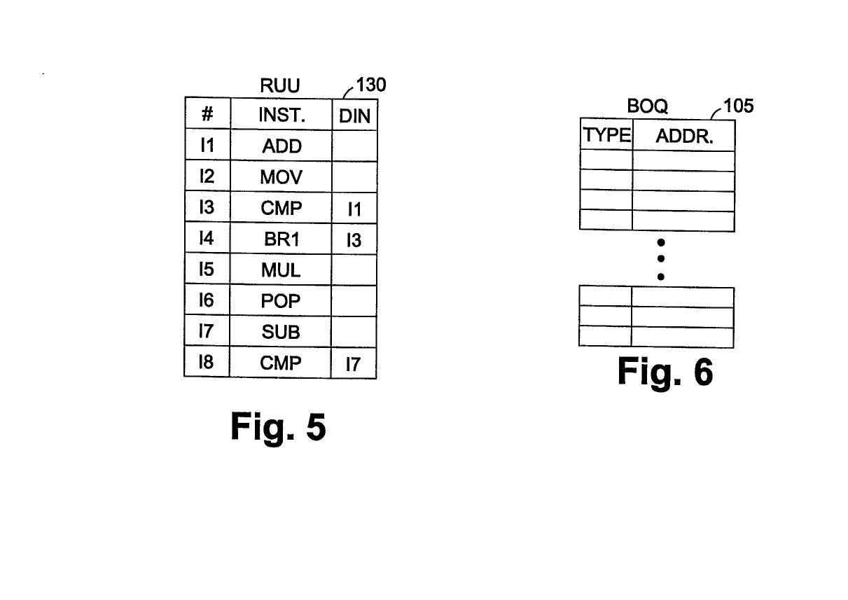

The RUU 130 also handles out-of-order execution management. As instructions are placed in the RUU 130, any dependence between instructions (e.g., one instruction depends on the output from another or because branch instructions must be executed in program order) is maintained by placing appropriate dependent instruction numbers in a field associated with each entry in the RUU 130. FIG. 5 provides a simplified representation of the various fields that exist for each entry in the RUU 130. Each instruction in the RUU 130 includes an instruction number, the instruction to be performed, and a dependent instruction number (“DIN”) field. As instructions are executed by the execution units 134, 138, 142, dependency between instructions can be maintained by first checking the DIN field for instructions in the RUU 130. For example, FIG. 5 shows 8 instructions numbered I1 through I8 in the representative RUU 130. Instruction I3 includes the value I1 in the DIN field which implies that the execution of 13 depends on the outcome of 11. Thus, execution units 134, 138, 142 recognize that instruction number I1 must be executed before instruction I3. Therefore, in the example shown in FIG. 5, the same dependency exists between instructions I4 and I3 as well as I8 and I7. Meanwhile, independent instructions (i.e., those with no number in the dependent instruction number field) may be executed out of order.

Referring again to FIG. 4, the floating point register 122 and integer register 126 are used for the execution of instructions that require the use of such registers as is known by those of ordinary skill in the art. These registers 122, 126 can be loaded with data from the data cache 146. The registers also provide their contents to the RUU 130.

As shown, the execution units 134, 138, and 142 comprise a floating point execution unit 134, a load/store execution unit 138, and an integer execution unit 142. Each execution unit performs the operation specified by the corresponding instruction type. Accordingly, the floating point execution units 134 execute floating instructions such as multiply and divide instruction while the integer execution units 142 execute integer-based instructions. The load/store units 138 perform load operations in which data from memory is loaded into a register 122 or 126. The load/store units 138 also perform store operations in which data from registers 122, 126 is written to data cache 146 and/or DRAM memory 92 (FIG. 1).

According to the preferred embodiment, the sphere of replication is represented by the dashed box shown in FIG. 4. The majority of the pipelined processor components are included within the sphere of replication 200 with the notable exception of the instruction cache 110 and the data cache 146. The floating point and integer registers 122, 126 may alternatively reside outside of the sphere of replication 200, but for purposes of this discussion, they will remain as shown. It should be noted that since the branch outcome queue 105 resides outside the sphere of replication, all information that is transmitted between the sphere of replication 200 and the branch outcome queue 105 must be protected with some type of error detection, such as parity or error checking and correcting (“ECC”). Parity is an error detection method that is well-known to those skilled in the art. ECC goes one step further and provides a means of correcting errors. ECC uses extra bits to store an encrypted code with the data. When the data is written to a source location, the ECC code is simultaneously stored. Upon being read back, the stored ECC code is compared to the ECC code generated when the data was read. If the codes don't match, they are decrypted to determine which bit in the data is incorrect. The erroneous bit may then be flipped to correct the data.

The architecture and components described herein are typical of microprocessors, and particularly pipelined, multithreaded processors. Numerous modifications can be made from that shown in FIG. 4. For example, the locations of the RUU 130 and registers 122, 126 can be reversed if desired. For additional information, the following references, all of which are incorporated herein by reference, may be consulted for additional information if needed: U.S. patent application Ser. No. 08/775,553, filed Dec. 31, 1996, and “Exploiting Choice: Instruction Fetch and Issue on an Implementable Simultaneous Multithreaded Processor,” by D. Tullsen, S. Eggers, J. Emer, H. Levy, J. Lo and R. Stamm, Proceedings of the 23^{rd} Annual International Symposium on Computer Architecture, Philadelphia, Pa., May 1996.

As discussed above, the predicted outcomes in the branch predictor 103 are based on training by previous executions of branch instructions. As more instructions are executed, the predictions tend towards the more common results. Thus, since the predictions are based on overall trends, it is not likely that a single misspeculation in a thread will generate a change in the predicted outcome even when the misspeculation is discovered. The branch predictor requires a more consistent history before a given prediction is changed. Therefore, while the slack fetch counter 104 provides enough of a delay for a trailing thread T1 to benefit from an update to branch predictor 103 that is generated by a misspeculation in the leading thread T0, the trailing thread will still misspeculate if the branch predictor 103 is not updated or if the branch predictor is simply wrong in speculating the outcome of the branch.

To remedy this situation, the BOQ 105 is coupled to the fetch unit 102. BOQ 105 is preferably a FIFO buffer that stores branch instruction outcomes from the leading thread T0 as the branch instructions are retired from the RUU 130. A FIFO buffer works effectively because, as discussed above, branch instructions in the leading thread are fetched and retired (but not necessarily executed) in program order. Thus, it is appropriate for the trailing thread T1 to simply fetch the oldest branch instruction outcome from the buffer. Furthermore, instead of probing the branch predictor 103, the trailing thread T1 simply fetches the actual branch outcome (as determined by execution of the corresponding branch in T0) from the BOQ 105.

BOQ 105 preferably comprises, at a minimum, the fields shown in FIG. 6. Entries in the representative BOQ 105 shown in FIG. 6 include an “Instruction Type” and a “Target Address.” The BOQ 105 may alternatively include program counter value field for each branch instruction. This value is the instruction number or identifier assigned by the program counter 106 when the branch instruction is fetched by fetch unit 102. The instruction type field correctly identifies the branch and allows the processor 100 to properly execute subsequent instructions. The target address is the address of the next instruction in thread T1 to execute. The target address therefore allows T1 to continue executing before the branch instruction is actually executed.

This method of branch prediction for the trailing thread provides a number of advantages. First, it guarantees, in the absence of transient faults, that branch misspeculations never occur in the trailing thread T1. Secondly, it guarantees that transient faults that do occur during execution of a branch instruction (in either T0 or T1) are detected. If a transient fault does occur during execution of a branch instruction, the effective addresses from the branch instructions in the redundant threads will differ and processor 100 will recover by re-executing the threads. Thirdly, the fact that the branch instructions are not placed in the BOQ 105 until the instructions retire means that a slack is inherently built into this fetch policy. If the BOQ 105 ever becomes empty, trailing thread T1 is stalled to permit instructions in leading thread T0 to retire. Conversely, if BOQ 105 becomes full, leading thread T0 is stalled to permit trailing thread to execute and therefore clear entries from the BOQ 105.

Accordingly, the preferred embodiment of the invention provides a significant performance increase of an SRT processor that can execute the same instruction set in two different threads. The above discussion is meant to be illustrative of the principles and various embodiments of the present invention. Numerous variations and modifications will become apparent to those skilled in the art once the above disclosure is fully appreciated. For example, the slack fetch and branch outcome queue features described herein are fully independent enhancements and may therefore be implemented jointly or individually in the absence of one another. The preferred embodiment of the SRT processor advantageously incorporates both features for improved performance. It is intended that the following claims be interpreted to embrace all such variations and modifications.

What is claimed is:

1. A computer system, comprising:
a pipelined, simultaneous and redundantly threaded (“SRT”) processor comprising a fetch unit that further comprises a branch predictor;
an I/O controller coupled to said processor;
an I/O device coupled to said I/O controller; and
a main system memory coupled to said processor;
wherein said SRT processor processes a set of instructions in a leading thread and also in a trailing thread and the SRT processor speculates on the outcome of branch instructions in the leading thread using the branch predictor, but wherein the SRT processor does not speculate on the outcome of branch instructions in the trailing thread and instead uses the actual outcome of branch instructions in the leading thread to predict the outcome of branch instructions in the trailing thread.

2. The computer system of claim 1 further comprising a branch outcome queue located in the fetch unit;
wherein the actual outcomes of branch instructions in the leading thread are placed in the branch outcome queue.

3. The computer system of claim 2 wherein the fetch unit accesses the branch outcome queue and not the branch predictor to predict the outcome of branch instructions in the trailing thread.

4. The computer system of claim 2 wherein the branch instruction queue is a FIFO buffer.

5. The computer system of claim 2 wherein the individual branch outcome entries in the branch outcome queue comprise a program type identifier and a target address for the location of the next instruction in the thread to be executed.

6. The computer system of claim 2 further comprising a register update unit;
wherein the register update unit is configured to hold instructions in a queue until the instructions are executed and retired by the SRT processor and wherein the outcomes of branch instructions in the leading thread are not placed in the branch outcome queue until the branch instructions retire from the register update unit.

7. The computer system of claim 2 further comprising a slack counter located in the fetch unit;
wherein the slack counter is configured to maintain an approximately constant number of instructions of separation between corresponding instructions in the leading and trailing threads.

8. The computer system of claim 3 wherein if the branch outcome queue becomes full, execution of instructions in the first thread is temporary halted to prevent more branch outcomes from entering the branch outcome queue; and
wherein if the branch outcome queue becomes empty, execution of instructions in the second thread is temporary halted to allow more branch outcomes to enter the branch outcome queue.

9. A pipelined, simultaneous and redundantly threaded (“SRT”) processor, comprising:
a fetch unit that fetches instructions from a plurality of threads of instructions;
a program counter configured to assign program counter values to instructions in each thread that are fetched by the fetch unit;
an instruction cache coupled to said fetch unit for storing instructions to be decoded and executed; and
decode logic coupled to said instruction cache to decode the type of instructions stored in said instruction cache;
wherein said processor is configured to detect transient faults during program execution by executing instructions in at least two redundant copies of a program thread and wherein misspeculation caused by incorrectly predicting the outcomes of branch instructions in a second program thread is avoided by using the actual outcomes of branch instructions in a first program thread to correctly determine the outcome of branch instructions in the second program thread.

10. The SRT processor of claim 9 wherein instructions in the first program thread execute in advance of the corresponding instructions in the second program thread thereby creating a slack of instructions between the first and second program threads and wherein said slack is sufficient to allow the SRT processor to resolve any misspeculation in the first program thread prior to providing correct branch outcome results to the second program thread.

11. The SRT processor of claim 10 wherein said fetch unit comprises:
slack counter configured to maintain a target number of instructions of separation between corresponding instructions in the leading and trailing threads.

12. The SRT processor of claim 9 wherein said fetch unit comprises:
a branch predictor for predicting the outcomes of branch instructions in the first program thread; and
a branch outcome queue for storing the actual outcomes of branch instructions in the first program thread;
wherein the actual outcomes of branch instructions in the first program thread are stored in the branch outcome queue after the branch instructions in the first program thread are retired by the SRT processor; and
wherein the fetch unit uses the branch outcome queue and not the branch predictor to predict the outcomes of branch instructions in the second program thread.

13. The SRT processor of claim 12 wherein the SRT processor is an out-of-order processor capable of executing instructions in the most efficient order, but wherein branch instructions are executed in the same order in both the first and second program threads.

14. The SRT processor of claim 13 wherein the branch outcome queue is a FIFO buffer and data is transmitted to and from the buffer using an error correction technique.

15. The SRT processor of claim 12 wherein the individual outcomes stored in the branch outcome queue comprise:
a program type classifying the branch instruction; and
a target address corresponding to the instruction to be executed immediately following the branch instruction;
wherein during execution of the second program thread, the SRT processor may identify the appropriate branch instruction using the program counter value and may also fetch instructions ahead of the branch instruction using the target address.

16. The SRT processor of claim 12 wherein if the branch outcome queue becomes full, the first thread is stalled to prevent more branch outcomes from entering the branch outcome queue; and
wherein if the branch outcome queue becomes empty, the second thread is stalled to allow more branch outcomes to enter the branch outcome queue.

17. A method of predicting branch instructions in an SRT processor which can fetch and execute a set of instructions in two separate threads so that each thread includes substantially the same instructions as the other thread, one of said threads being a leading thread and the other of said threads being a trailing thread, the method comprising:
training a branch predictor to store predicted outcomes from branch instructions in the leading thread;
probing the branch predictor to predict outcomes of future executions of branch instructions in the leading thread;
storing actual outcomes of branch instructions in the leading thread in a branch outcome queue;
probing the branch outcome queue to predict outcomes of corresponding branch instructions in the trailing thread.

18. The method of claim 17 further comprising:
executing the branch instructions in the leading and trailing threads in program order.

19. The method of claim 18 further comprising:
storing the actual outcomes of branch instructions in the leading thread in the branch outcome queue after the branch instructions retire;
wherein the outcomes are identified by a branch identifier and a target address signifying the subsequent instruction to be executed as a result of the outcome of the execution of the branch instruction.

20. The method of claim 18 further comprising:
using a FIFO buffer as the branch outcome queue;
wherein if the buffer becomes full, the leading thread is stalled to prevent more branch outcomes from entering the buffer; and
wherein if the buffer becomes empty, the trailing thread is stalled to allow more branch outcomes to enter the buffer.

21. The method of claim 18 further comprising:
transmitting data to and from the branch outcome queue using an error correction technique.
